(19) United States
(12) Patent Application Publication
(10) Pub. No.: US 2007/0118514 A1
(43) Pub. Date: May 24, 2007

(54) Command Engine

(76) Inventor: Rangaraju Mariappan, Timonium, MD (US)

Correspondence Address: John J. Yim, Esq., 4th Floor, 1750 Tysons Blvd., McLean, VA, 22102, US

(21) Appl. No.: 11/599,426

(22) Filed: Nov. 15, 2006

Related U.S. Application Data
(60) Provisional application No. 60/738,085, filed on Nov. 19, 2005.

(51) Int. Cl. G06F 17/30

(52) U.S. Cl. 707/3

(57) ABSTRACT

A command engine of the present invention correlates user intentions with website capabilities. Rather than merely matching words against indexes, user intentions are approximated and desired results are retrieved directly, bypassing multiple steps in the process. Preferably, the user query is written as an action verb in “do” and an object in “what”. Additional prepositional phrases further determine user intentions.

### REFERENCE TO PRIOR PROVISIONAL APPLICATION

This application claims the benefit of and incorporates by reference U.S. Provisional Application No. 60/738,085, filed Nov. 19, 2005.

### BACKGROUND OF THE INVENTION

1. Field of the Invention

This invention relates to an information capturing or information retrieving system.

2. Background of the Invention

Search engines generally enable a user to locate a website that the user is looking for by allowing the user to enter a user input. The user input is then processed in a variety of ways, usually by comparing the user input against an index that contains a pointer, key, web-address (URL), database, or tables from a specific web page on the World Wide Web.

Commonly available Internet search engines may find a web page by matching character strings that a user inputs against an index obtained by storing character strings found on a web page or in the metadata of a web page. No distinction is usually made between the parts of the speech of the character strings entered by the user. For example, “pay” will be stored as a string of characters “p-a-y” and matched with an entry for “p-a-y” in the database without regard to the meaning or parts of the speech of the word.

Some Internet search engines employ various techniques to improve the search. For example, a term-frequency test may be used to determine which term on a web page most accurately describes the page. Some Internet search engines may augment the user's query by including synonyms for a user input. Some search engines may remove suffixes to augment the search. Some search engines may allow the user to use Boolean operators (e.g., “AND”, “OR”, “NOT”).

Search engines use various indexing techniques that are generally similar to the indexing schemes used by book publishers. There are, however, significant differences. For example, content of some websites may be dynamic, with information being changed or updated, while content of books tend to be static. Also the Internet provides different online services such as sending correspondence and allowing users to buy and sell items.

Currently available Internet search engines such as Google may return multiple search results, some of which may not have any relevance to the user's intentions. In creating indexes for such a search engine, huge numbers of strings of characters may be processed without regard to meaning of the words or the objectives of the user's intentions. Search results may be produced by comparing the strings in these indexes with the strings found in the user input. As a consequence, such searches may result in returns of 100s or 1000s of URL addresses.

But because it is not often clear which of these URLs best describe what the user is trying to accomplish, these search engines usually return a link to several websites rather than taking the user to a specific webpage. These Internet search engines also do not take full advantage of the capability that many web-sites now offer with the availability of web services that can further direct the user to the intended webpage. Search engines often do not provide a direct answer to the user's question. Search engines often do not produce results that correspond to the user's intentions.

### SUMMARY OF THE INVENTION

This invention relates to an information capturing or information retrieving system, and more specifically to a new type of system that enhances a user's ability to locate information that the user is trying to retrieve by taking into consideration the parts of speech of a user input.

The present invention makes a more efficient use of a user's input to an information capturing or information retrieving system by considering the information that are inherent in the part of speech of a word. For example, an action verb may denote a desire to do something. This information can be used to better understand the user intention and to return a more-targeted response to a user input.

The present invention mimics the capabilities of the human brain. For example, when a person has the intention of hanging a picture, he may use a hammer and a nail. When the person has the intention of sleeping, he may go to bed. When he needs to know the time, he may look at a clock. Here, hanging a picture, finding out the time of day, and sleeping are the person's intentions. Taking these desired goals, the human brain instructs the person to make use of a hammer and nail, a bed or a clock, to achieve the different desired goals.

Similarly on the Internet, if a user can express his intentions of doing something, it would be advantageous and desirable to be able to take him directly to a particular website, which has the exact answer to his particular intention. For example, if a user has the intention of finding “driving direction” from point A to point B, the present invention will take the user to a webpage displaying the driving directions directly. Instead of as in the prior art search engines, where the user is first directed to various websites having maps and directions, such as maps.google.com or mapquest.com, only to have the user input the information, such as addresses, for point A and point B. The present invention, sometimes referred to herein as a command engine, allow the user to put in the user's intentions as a query and receive the desired results as an immediate result of the user's query.

### BRIEF DESCRIPTION OF THE DRAWINGS

The accompanying drawings, which are incorporated herein and form part of the specification, illustrate the present invention and, together with the description, further serve to explain the principles of the invention and to enable a person skilled in the pertinent art to use the invention.

FIG. 1 is a schematic diagram illustrating the role of an information retrieval system.

FIG. 2A is an example of a search engine user interface.

FIG. 2B is an example of the user interface for an embodiment of the present invention.

FIG. 2C is an example of the user interface for an embodiment of the present invention.

FIG. 2D is an example of the user interface for an embodiment of the present invention.

FIG. 3 is a system diagram showing an embodiment of the present invention.

FIG. 4A is a screen shot of an embodiment of the user interface of the present invention.

FIG. 4B is a screen shot of an embodiment of the user interface of the present invention.

FIG. 4C is a screen shot of an embodiment of the user interface of the present invention.

FIG. 4D is a screen shot of an embodiment of the user interface of the present invention.

FIG. 5 is a schematic diagram showing an embodiment of the user interface of the present invention that is adopted for use as an Internet command engine.

FIG. 6A is a screen shot of the user interface of an embodiment of the present invention that is adopted for use as an Internet command engine.

FIG. 6B is a screen shot of the user output of the embodiment in FIG. 6A that is adopted for use as an Internet command engine.

FIG. 7A shows a user input to another embodiment of the present invention that is adopted for use as an Internet command engine.

FIG. 7B shows a number of user inputs that can be used with the embodiment of the present invention in FIG. 7A that is adopted for use as an Internet command engine.

FIG. 7C shows a user input that can be used in the embodiment of the present invention in FIG. 7A that is adopted for use as Internet command engine and how it can be processed to generate a query.

FIG. 8A is a node diagram of a noun phrase grammar network.

FIG. 8B is a node diagram of a second noun phrase grammar network.

FIG. 8C is a node diagram of a verb phrase grammar network.

FIG. 9 is a screen shot of a website registration form for another embodiment of the present invention that is adopted for use as an Internet command engine.

FIG. 10 is a diagram for an embodiment of a command engine architecture.

### DETAILED DESCRIPTION OF THE PREFERRED EMBODIMENTS

A command engine of the present invention correlates user intentions with website capabilities. Rather than merely matching words against indexes, user intentions are approximated and desired results are retrieved directly, bypassing multiple steps in the process. Preferably, the user query is written as an action verb in “do” and an object in “what”. Additional prepositional phrases further determine user intentions. The command engine of the present invention interprets a user's query and provides a direct answer to the user's question or intentions. The present invention understands a user's intentions or uses the query to interpret the user's intentions.

The command engine of the present invention acts preferably as a broker between user intentions and web sites capabilities. A user intention can be the objective or a goal of a user in submitting a query. And a website's capability, services that it may offer, abilities or information that it may possess, among others. The command engine of the present invention complements a search engine.

Using command engine, users command the web rather than just using it for searching the web. As a default, a command engine possesses capabilities to search as in search engines. For example, if a command engine cannot interpret a user intention, then it may default to a search engine. In one embodiment, a search engine as known in the art may be a part of a command engine of the present invention. Also, for example, when the verb of the user input sentence requests a search, as in “search” or “Google” or “ask Jeeves” or “yahoo” for example, the command engine may direct the user input directly to the requested search engine or to a default search engine.

In a preferred embodiment, the present invention utilizes a sentence structure query comprising a verb phrase, a noun phrase, and one or more prepositional phrases. Thus, a query may be structured as “do (as in ‘find’)”, “what (as in ‘jobs’)”, “preposition phrase(s) (as in ‘in San Francisco’)”. The present invention preferably uses a query having a single sentence structure. The command engine of the present invention may also use certain natural language processing tools to generate certain indexes from a user typed sentence.

In the preferred embodiment, the command engine of the present invention comprises natural language written queries in two parts. First, user shall provide a word which is a verb phrase. Any verb in a dictionary can be specified and it will be consider as a command of the user. And the second part can have a noun phrase, plus one or more preposition phrases.

Preferably first, the command engine of the present invention may identify the different phrases of the sentence. Such phrases may be used as indexes for the query. The process in which indexes generated by a command engine is different than search engine indexes. First, the verb and predicate phrase will create an important unique key index to search the database. And each preposition phrase makes additional index to search. The preferred grammar structure of a command query can be:
Command Sentence=“Help me to”+<verb>+<predicate phrase>+0 or more of <“preposition”+Noun phrase>.

The grammar structure supported by command engine can be expanded or changed according to the natural language structure. But in the preferred embodiment, a user preferably uses a defined or restricted grammar structure to input queries that result in a command style sentence. Advanced grammar interpretation is also contemplated in the present invention and thus may deviate from the structure in the preferred embodiment.

The command engine of the present invention, however, provides a flexible grammar structure so that a user can type her intentions in a very flexible manner within such guidelines. Even if the user's query does not exactly conform to the preferred grammar structure, however, the command engine of the present invention preferably parses the sentence against supported grammar structure to generate the desired result.

The verb plus predicate format of the preferred embodiment enables the command engine to understand the user's intentions. Furthermore, the prepositional phrases also provide additional information regarding user intentions.

The command engine of the present invention may utilize various methods to collect information from the Internet. Some examples include manual collection of information, directory registration and crawlers. Also, it may also have self learning mechanisms as known in the art using artificial intelligence techniques.

Using a manual method, for example, a command engine administrator may process capabilities of a website using methods as known in the art, such as by using simple db interfaces. Any website publisher may also submit their sites using an input mechanism provided by a command engine. In such interfaces, the command engine may ask the website publisher information and capabilities concerning the website. Also, crawlers designed to feed the command engine of the present invention may use special tagged information in their web pages, for example. Command engines may also have check systems to verify the information and capabilities collected or processed. Furthermore, automatic crawler may automatically populate the command engine database with website capabilities and link user intentions to desired results.

The command engine of the present invention also may parse user given sentences into different phrases. Each word may also be tagged with its type like noun, pronoun, verb, preposition, adverb, adjective, etc. The command engine may also maintain a database for the English language grammar specialized for command engine request. The command engine may use an Augmented Transition Network (ATN) parser to split a sentence into to different phrases, for example. In ATN, grammar of a language is defined in terms of network nodes and edges. This information can be stored in tables. With ATN parser, grammar of the language can be changed according to the environment or language or dialect used and the parsing modules works independent of the grammar. The grammar of language may also be defined in a data structure. It may be changed or modified and improved.

Furthermore, as known in the art, context free grammar parser may take tagged word lists and attempt to different phrases of the sentence. In the output, each phrase may be tagged with its grammatical identity, such as noun phrase, prepositional phrase, and the like. Noise filters may also examine a user's input and eliminate unnecessary words as known in the art. Furthermore, as known in the art, banyan tree modules may help reduce redundancy. Also, db QUERY generators may combine different phrases to conform to the query format of the preferred embodiment.

The command engine may prepare html results to present the answer it found sent it to the user. Command engines may also be used for desktops or for OS. Command engine queries may also transform commands into an OS command. On a unix, for example, ls-al /opt/Netscape/tmp

can be really express on a command engine as “list” or “files in /opt/Netscape/tmp with detail option”. Additional examples listed in the provisional application are incorporated herein by reference.

Every web site should be able to post its services in terms of noun, verb, and preposition combination. Such information may be expressed in well known format using XML, for example. Services can be presented to user using standard User Interfaces, such as “do: and this:”. General purpose command engine crawlers can also be written to visit pages to find different kind of commands a web site supports.

Also, every website may register with the command engine for the services it can provide in terms of verbs, nouns and propositions. A command engine powered user or software should be able to issue commands to a central engine to get different kind of help to achieve their mission.

Furthermore, a command engine may have multiple functionalities to take on more than one sentence query per search. Thus, the command engine may coordinate multiple command engine queries. For example, each morning when a person wakes up he may like to do various things on the web. These may include checking the weather, traffic, school schedule, stock quotes, recent news, on a given weekday. Such activities may include checking the email, for example. The command engine of the present invention allows the user to, for example, enter a single query, such as “do: retrieve; what: daily inquires” to retrieve all of the daily requests in a single command.

The command engine of the present invention is a broker between a user's intentions and websites' capabilities. Generally, the command engine of the present invention indexes website capabilities and website services.

The present invention can be applied to any kind underlining protocols as known in the art, including, for example, http, RSS Feed, Atom, ftp, web-service, xmlrpc, and SOAP. In general, if a service is provided by any entity which has an address, then it can be registered and accessed through the command engine of the present invention. Also, the protocols do not need to be limited to network protocols like http.

As an illustrative example, the command engine of the present invention can index operating system capabilities with commands. For example, ‘reboot’ can be indexed in command engine as a command to “restart the system”. Similarly, ‘mv’ can be indexed as a command to “move file from location x to location y”. Likewise, ‘eject’ can be indexed as a command to “open the CD drive”.

Furthermore, an individual's capabilities can even be indexed for use by a command engine of the present invention by indexing the person's phone number and/or address. For example, if an individual provides services of home-based guitar lessons in the Towson, Md. area, her capabilities can be indexes as
Command: “learn guitar lessons in Towson, MD”
Address: “John Murry, 441-378-4333”

Thus, the person does not need to have a web site to publish her business. Just publishing his phone number can be good enough. Command Engine web capability processing component shall have plug-in modules per protocol or per type of services so that any kind of service can be indexed centrally made available for the user.

Furthermore, as web sites are registered with command engine, there will be thousands and limitless numbers of commands available. A user may not remember all of the available commands for use on the command engine of the present invention. For example, a command may not be spelled correctly. To facilitate the users, the command engine of the present invention may then preferably index key words in each command as search engines index web content.

For example, when a user express his intention with words or phrases or sentence, the command engine of the present invention may find a matching command for the sentence query. If a match is not found, the command engine may search the indexed word database of commands to suggest what the user may be looking for. For example if a user searches with command engine as “driving direction”, the command engine may start to suggest commands like “drive from - - - to - - - using Google map”, “get driving direction from - - - to - - - using yahoo map”, and “drive from address - - - to address - - - using AAA map”.

Once the user chooses the desired command and fills in the blanks, the command can be submitted to retrieve the desired result. Using this search technique, a user can find the closest answer in response to a query. For example, “drive Google” may retrieve the website for inserting driving destinations from Google. But at the same time, if a user knows that the command for retrieving driving directions from Google is “drive from - - - to - - - using Google Maps”, then the user could have received her ultimate result immediately in a single step.

Also, command Engine can also further personalize usage providing ‘personalized’ commands. For example, by putting in a command query, such as ‘I want to drive from ‘my home’ to ‘my school’’, the command engine of the present invention may allow the user to tag different words like ‘my home’, ‘my school’, ‘my name’, ‘my email account’, and ‘my favorite songs’. The command engine of the present invention would then associate specific information with such commands, for example by substituting the user's name with ‘my name’ to personalize the command query.

In certain instances, a command may not have all the requisite key words that a user may need. For example, the command query of ‘I want to drive from - - - to - - - ’ may be a complete sentence to the registrant. But it may lack certain words such as map, traffic, route, and trip mileage. Thus, in the command registration process, a user may be allowed to provide extra key words. These additional words then can be indexed along with the command. Furthermore, the user may be allowed to provide the description of the service associated with a certain word in the description section. These additional features may assist the user in understanding the command/service that the user is using.

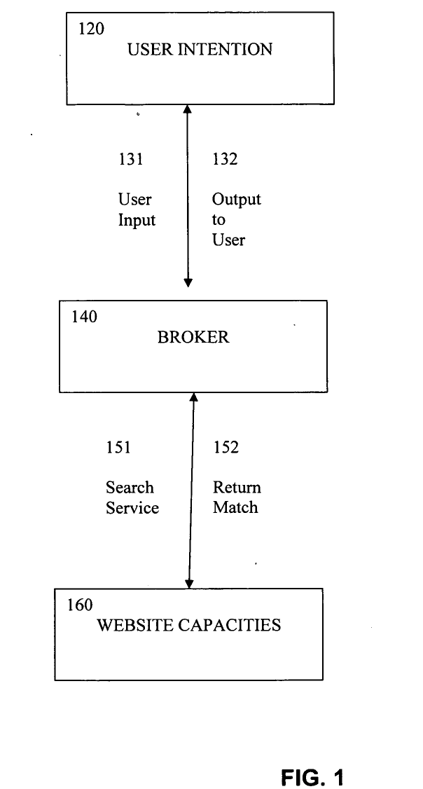

The present invention is a super set of search engines and an information capturing or information retrieving system. FIG. 1 is a schematic diagram illustrating the role of an information retrieval system that is adopted to search web capacities. In this embodiment of the present invention, command engine may be a broker 140 between user intention 120 and website capabilities 160. User intention 120 may be the particular thing that a user wants to achieve in a single transaction such as a single web search. The type of services available on the web is called web capabilities 160.

The present invention tends to aid or lead its user to the tools that help the user accomplish his intentions. An index is a structured sequence of synthesized access points to the information contained in a search area. The structured arrangement of the index enables a user to locate information more or less efficiently.

Currently available search engine such as yahoo.com visits the web and index the keywords of each web pages to build an index that matches a URL with a word, or more accurately a string of characters. It does so without interpreting the word or trying to interpret the user intention. A verb or a command is not treated any differently from a noun.

In contrast, the command engine of the present invention uses parts of speech as additional information in understanding the user intention 120 to locate the information that the user wants to retrieve.

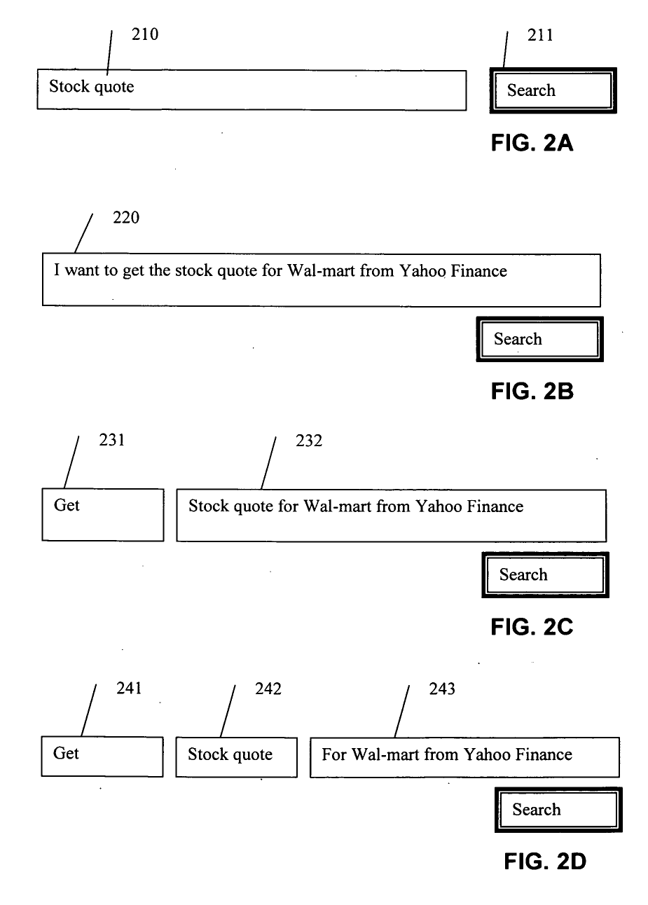

FIG. 2A is an example of a search engine user interface. Currently available search engines such as yahoo.com direct the user to enter any key words to conduct a search of those words in the web. A user can enter a key word in a user input field 210, and select the search button 211 to initiate a search. The search engine then locates the URLs of websites which match the key word and return them to the user.

FIG. 2B is an example of the user interface for another embodiment of the present invention. A user can enter a sentence, a phrase, and/or a number of phrases that best describe the user intention in a user input field 220.

FIG. 2C is an example of the user interface for a preferred embodiment of the present invention. In this embodiment, the user interface allows the user to enter a verb or a command in a first user input field 231 and to enter the subject of the sentence and the prepositional phrase that describe the subject in a second user input field 232. This user interface provides guidance to a user who may be unfamiliar with the way a command engine works.

FIG. 2D is an example of the user interface for another preferred embodiment of the present invention. Here, the user input is further broken down into several parts of speech: (1) the first user input field 241 for a verb, (2) the second user input field 242 for an object, and (3) the third user input field 243 for one or more prepositional phrase that describes the object. English grammar structure is complex, and several other variations for user interface are possible. Also, the concepts of the present invention can readily be applied to languages other than English.

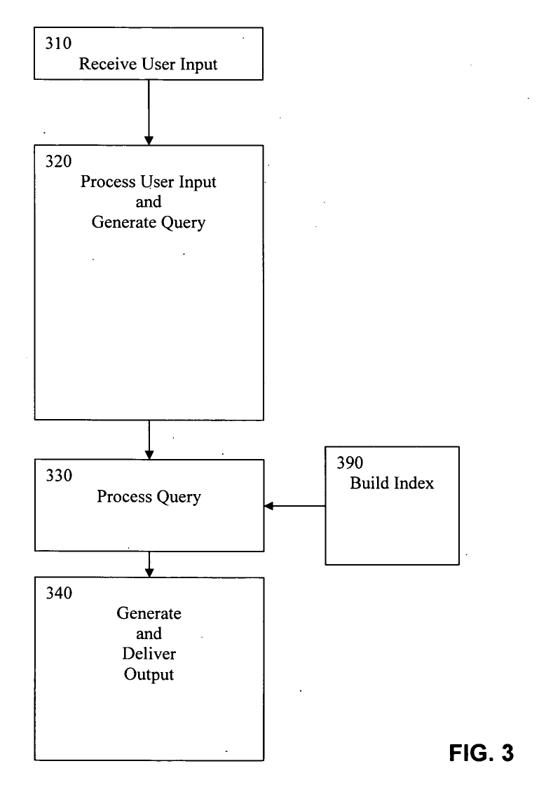

FIG. 3 is a system diagram showing another embodiment of the present invention. First, a user provides a command engine with a user input in Step 310. The user input may then be processed by the user input processor and query generator in Step 320 to produce a query. The query may then be processed in a query engine in Step 330. The query engine returns a return value that matches the user input received in 310. The return value is used by an output generator to generate and to deliver an output to the user in Step 340.

The query engine used in Step 330 may optionally use an index to process the query generated in Step 320. The index can either be provided by the programmer or an automated process can be set up to build the index as shown in Step 390.

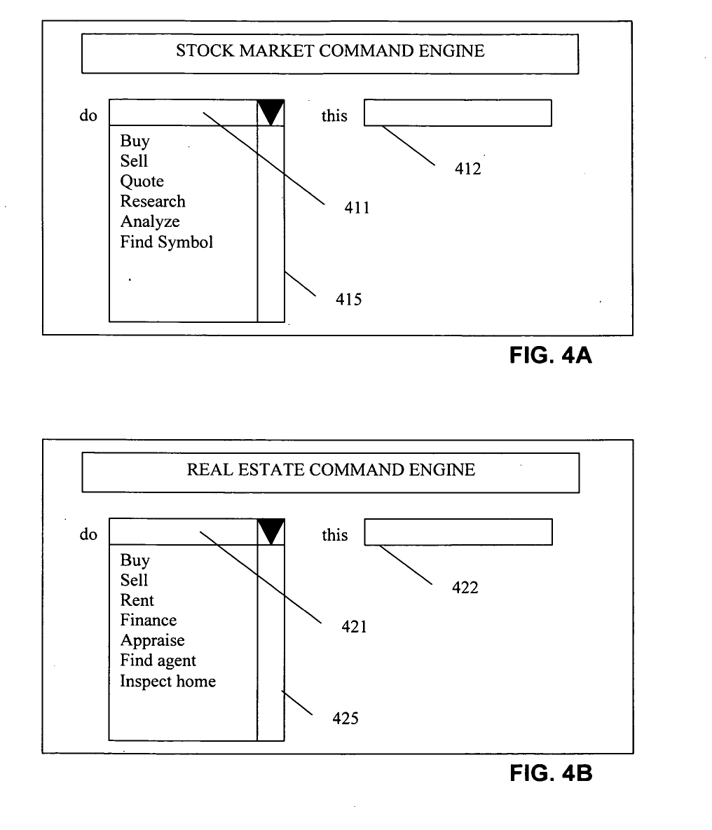

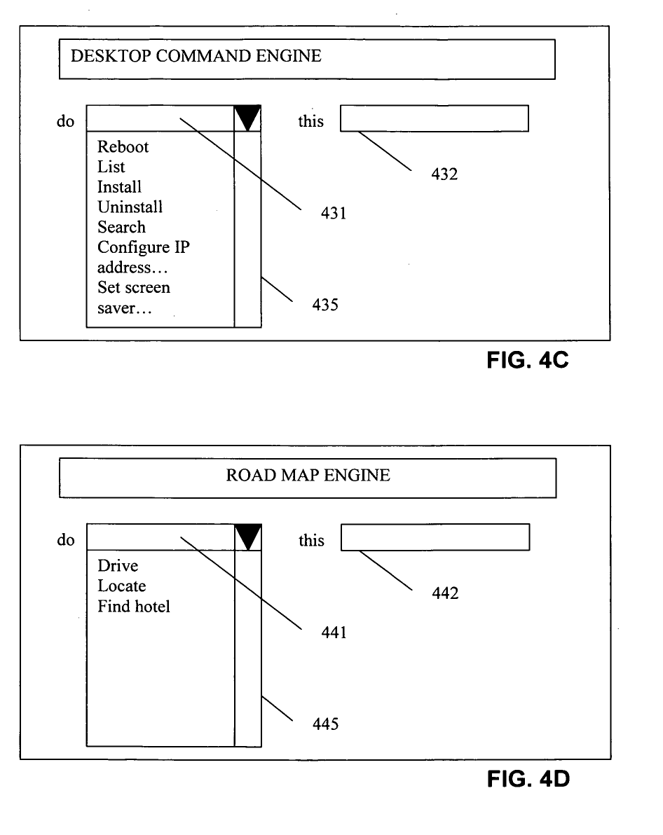

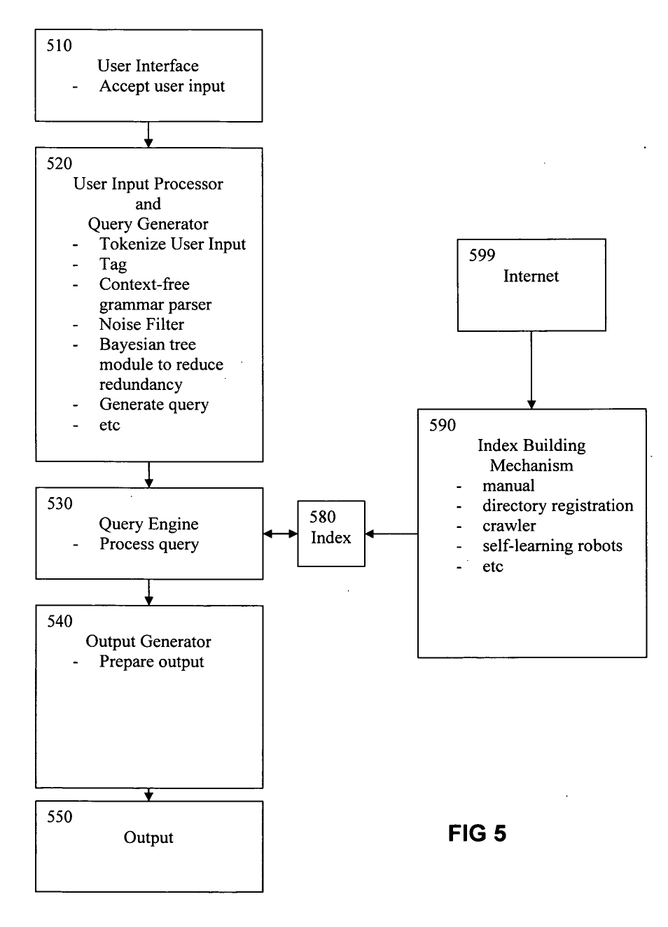

In Step 310, the user input is usually accepted through a User Interface. There are many ways to implement a user interface. For example, the user interface can allow a user to select a verb from a drop down menu and then to enter a subject in a separate user input field. An example of such a user interface is shown in FIG. 4A. The user interface can also allow a user to enter a verb and the rest of the predicate in one text box. An example of such a user interface is shown in FIG. 2C. The user can enter a sentence or a phrase. The user interface can also allow the user to enter a whole sentence as a user input. An example of such a user interface is shown in FIG. 2B.

The way a user input was received in Step 310 may affect the way the user input may be processed in the user input processor and query generator in Step 320. If a whole sentence was received as a user input, for example, the user input processor may be implemented to tokenize the user input into strings of words. For example, a user input such as “find the stock quote for Wal-mart” may be tokenized into “find,” “the,” “stock,” “quote,” “for,” and “Wal-mart.” To generate the appropriate query, some noises such as “the” may be filtered out. A key verb or command verb such as “find” may be tagged as a key command. A key phrase such as “stock quote” may be paired together and tagged as a key noun phrase.

In Step 330, the query generated in Step 320 may then be processed to determine a return value that matches the user input received in 310. This can be accomplished in various ways. One way is to compare the query to an index.

There are multiple ways to structure a query. As an example, for an Internet command engine, the query may be formed as “buy (command verb): house (key object): in (prepositional phrase—injunction): Fairfax (prepositional phrase—noun).” The index may have appropriate columns for command verb, key object, prepositional phrase—injunction or other descriptors, and prepositional phrase—noun to locate the best match for the query. The return value may be a URL of a web page. For an application software, for example a software for stock market command engine shown in FIG. 4A, the query may include “Quote” as a command verb and “Wal-mart” as a key object. The return value may be a number that represents the stock quote.

The return value, from Step 330 is delivered in a meaningful way to the user in Step 340. For example, for an Internet command engine that is used by the user to locate a webpage, the webpage should be opened on an Internet browser. Alternatively, the URL can be provided with a hyper-link so that the user can open the webpage. For a stock market command engine shown in FIG. 4A, the stock quote may be displayed on a screen so that the user can read it. There are many ways to implement Step 330 as known in the art.

FIG. 4A is a screen shot of another embodiment of the user interface of the present invention. In this embodiment, a command engine is adopted for use in application software that answers queries about stocks. In this user interface, a user can choose a command verb from a drop down menu 415 for a first user input field 411. More specific user input can be entered in a second user input field 412. For example, selecting “quote” for the first user input field 411 and entering “Wal-mart” in the second user input field 412 will yield the stock quote for Wal-mart. This embodiment can be implemented as application software or as a website.

FIG. 4B is a screen shot of another embodiment of the user interface of the present invention. In this embodiment, a command engine is adopted for use in an application that aids real estate transactions. A drop down menu 425 is used to limit the command verbs that a user can enter. The application can be programmed in different ways so that a second user input field 422 may take the full address of a real estate, including the city name, zip code, or other information.

FIG. 4C is a screen shot of another embodiment of the user interface of the present invention. This embodiment shows a command engine that can be used as a part of an operating system. A drop down menu 435 is used to guide the user in choosing the right command verb. A second user input field 432 can be implemented in a variety of ways to allow the user extra freedom in commanding the operating system.

FIG. 4D is a screen shot of another embodiment of the user interface of the present invention. This embodiment shows a command engine that is adapted to locating road information.

FIG. 5 is a schematic diagram showing another embodiment of the user interface of the present invention that is adopted for use as an Internet command engine. The embodiment will be described in detail, but as with other descriptions, the present invention is not limited to this embodiment. This embodiment is provided to illustrate how a command engine may be implemented.

This embodiment can be implemented as a website, much like yahoo.com. However, the command engine of the present invention can provide capacities that are beyond that of a search engine such as yahoo.com. While yahoo.com allows the user to search the web, the command engine of the present invention allows the user to command the web.

In Step 510, a user enters a user input into a user interface. The user can enter verbs, nouns, propositional phrase, and other parts of speech in natural language. As discussed, the preferred embodiment is the very, noun, and one or more prepositional phrase(s).

For example, the user can enter “I want to buy a house in Washington DC.” This step can also be implemented so that there will be multiple user input fields or drop down menu like the one shown in FIG. 4A. Multiple user input field allows the programmer to guide the user to enter the right types of query. It may also simplify the user input processing in Step 520. For this embodiment, the default command verb is “search.” The command engine can either direct the user to a search engine like google.com or search the web using a method that incorporates parts of speech of the user input. For this embodiment, the user will be able to input only one sentence at a time.

In Step 520, the user input from Step 510 is processed to generate a query. For example, a whole sentence entered by the user, e.g., “I want to buy a house in Washington DC,” is tokenized and tagged. “Buy” is the command verb and is tagged as such. “House” is the key object and is tagged as such. Prepositional phrases such as “in Washington DC” can be tokenized into “in” for prepositional phrase-injunction and “Washington DC” for prepositional phrase-noun. There are many ways to determine which word is the command verb and which word is the key object in a sentence that best approximate the user intention. It is possible to express the same idea in a multiple ways in a given language, and Step 520 can be implemented to accommodate a wide range of expressions.

Some words entered by the user might not be essential in formulating a query. Also, past tenses, passive voices, or other language devices can be ignored. Past tenses can be substituted with active verb and some non-essential words such as “I want” can be filtered out. The sentence is treated so that verbs, nouns, and other language components are recognized to formulate a query that best approximate the user intention from a given user input. Step 520 should produce a query that can be used in Step 530.

In Step 530, the query generated in Step 520 is used to determine a user output by processing the query against an index 580 of key words and URL. The index 580 can be implemented in many ways. For example, the index may be composed of a table called KeyedURLsTable with columns of: command verb, key object, prepositional phrase-injunction, and prepositional phrase-noun. An entry for www.monster.com, a website for job search, can look like the following:

| | | | Preposit. | Preposit. | |
|---|---|---|---|---|---|
| Dbid | Verb | Object | Inj. | Noun | Webpage-URL |
| 1 | Find | Job | — | — | www.monster.com |
| 2 | Find | Job | In | San | www.monster.com/ |
| | | | | Francisco | location=San francisco |
| 3 | Find | Job | For | Nursing | www.monster.com/type= |
| | | | | | nursing |
| 4 | Find | Job | For | *** | www.monster.com/ |
| | | | | | type=*** |

Here the *** can be defined as a wild card and the URL can be changed according to the wild card value.

The index can also have a second table called combination-table. The table can have columns of combination bids, and can look like the following:

| Dbid | Combinationdbids | Webpage-URL |
|---|---|---|
| 1 | 2 & 3 | www.monster.com/location= |
| | | bayarea&type=nursing |

The entry shown above will return the URL of a webpage of a monster.com that is directed specifically to a job in the bay area (San Francisco) in the nursing field. Such an entry makes it possible for a user to by-pass layers of web pages before the user get to the web page that best approximate the user intention. For example, using a conventional Internet search engine, a user may have to: (1) search for a job search engine, e.g., Monster.com, at an Internet search engine, e.g., www.yahoo.com; (2) click on the link for Monster.com found at www.yahoo.com; (3) enter the main webpage of monster.com; and then (4) enter search values for “bay area” and “nursing” in the query field of monster.com. But with the present invention, the user can enter her user input “I want to find a nursing job in San Francisco” and be directed to the desired target webpage with a single mouse click. The way the index is set up in Step 580 affects the way a query can be processed in Step 530.

The query engine of Step 530 can determine the webpage that the user is looking for by comparing the query against the index provided in Step 580. The index may be prepared in Step 590. There are multiple ways to implement Step 590.

First, the programmer can manually build an index. Other options are to set up: (1) a directory registration; (2) a web crawler; or (3) a self-learning robots, etc. Since the web capacities available on the Internet changes, it may be preferable to set up a dynamic way for the index 580 to be updated. Also, the directory registration can be set up so that website owners can register their own websites, creating an entry in the index provided in Step 580. Implementing a web crawler is a little more complex. The website designers of individual webpage can include information about the command verb, key noun, or prepositional phrase that best describes their web pages, much like the way that they now include a meta data in html so that their website would be visible to conventional search engines. Self learning robots which use artificial intelligence (“AI”) techniques can also be set up.

In Step 530, the query generated in Step 520 is processed. The search engine can utilized several focusing techniques. There are several ways to implement a focusing technique. One way is to parse the query. For example, “Help me to buy cheapest red big organic tomato near zip code area 21093,” may result in a query that looks like: Buy (command verb): Tomato (key object): cheapest (adjective 1): red (adjective 2): big (adjective 3): organic (adjective 4): near (prepositional phrase—injunction): zip code 21093 (prepositional phrase—noun). Using the command verb “buy,” the query engine can narrow the search result to certain entries in the index. Search can be farther conducted for:

| | | | | | | |
|---|---|---|---|---|---|---|
| Cheapest | red | big | organic | tomato | near | zip code 21093 |
| | red | big | organic | tomato | near | zip code 21093 |
| | | big | organic | tomato | near | zip code 21093 |
| | | | organic | tomato | near | zip code 21093 |
| | | | | tomato | near | zip code 21093 |
| | | | | tomato | near | zip code 21*** |
| | | | | tomato. | | |

Another way is to assign points to determine which webpage best approximates the user intention. For example, 16 points can be assigned to a search result if the command verb and the key object from the query generated in Step 520 match the command verb and key noun on a table in index 580. For each prepositional phrase match, 4 points can be assigned. For each adjective match, 1 point can be assigned. The entry with the highest points will determine the return value. The return value may be a Web-page URL. The Web-page URL can be forwarded to output generator in Step 540 to generate a user output.

In Step 540, the web-page URL obtained in Step 530 can be used to produce an output 550 that is meaningful to the user. For example, that webpage can be opened on an Internet browser.

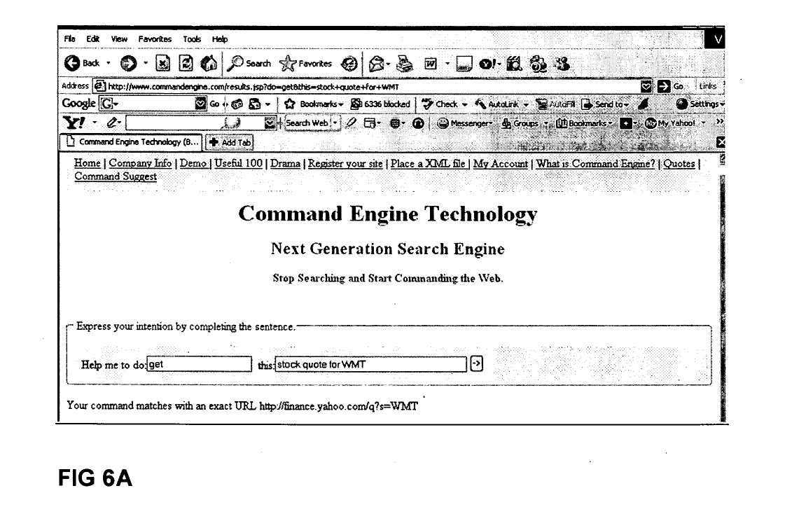

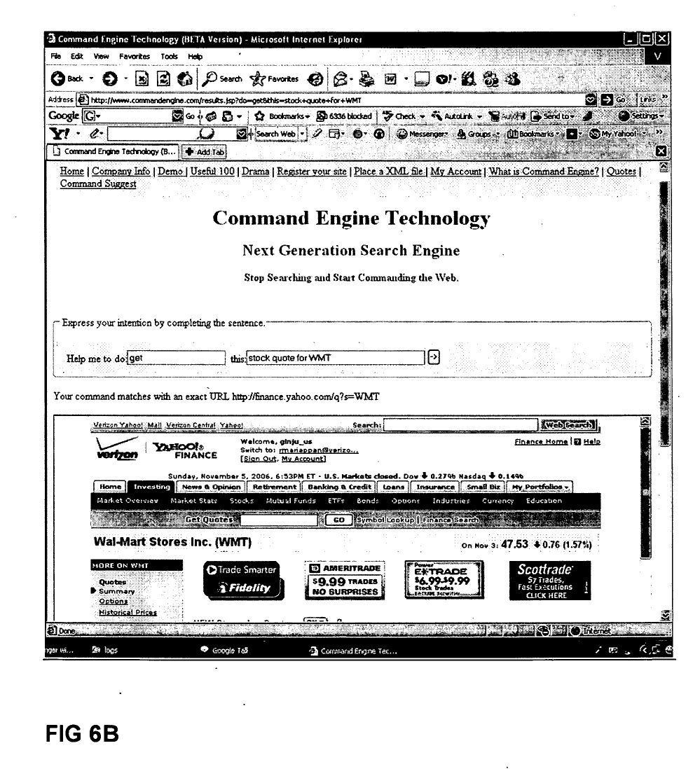

FIG. 6A is a screen shot of the user interface of another embodiment of the present invention that is adopted for use as an Internet command engine. The user interface can be opened on a conventional web browser as shown. User inputs can be entered in a first user input field (verb phrase), following “Help me to do”, and a second user input field (object phrase with prepositional phrases) following “this”. In the example shown in FIG. 61, the verb phrase is “get me” and the object phrase is “stock quote” with preposition phrase “for wmt”, which is the stock symbol for Wall-Mart Stores, Inc.

FIG. 6B is a screen shot of the user output of the embodiment of the present invention in FIG. 6A that is adopted for use as an Internet command engine. Here, the user output for user input “get me stock quote for wmt” is processed and a webpage corresponding to that user input is opened in an output window. As shown, in a single step, the user inputs of FIG. 6A displays the results of FIG. 6B.

This embodiment allows the user to skip several layers of webpage to be directed to the webpage that the user intends to visit. For example, the user no longer has to: (1) first visit yahoo.com to find a website for looking up stocks; (2) go to that website's main page and enter “Wal-mart” in the website's search field; (3) and then be directed to the webpage that shows the stock quote for Wal-mart. One way to achieve this result is through a new standard called Web service. Web service is XML based protocol to access the services provided by a web server.

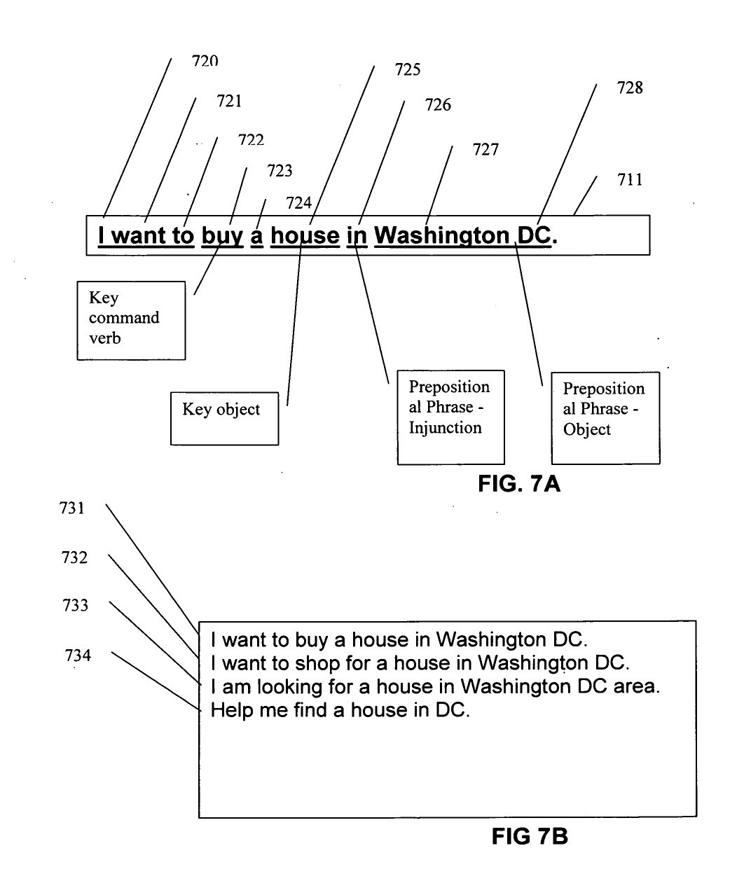

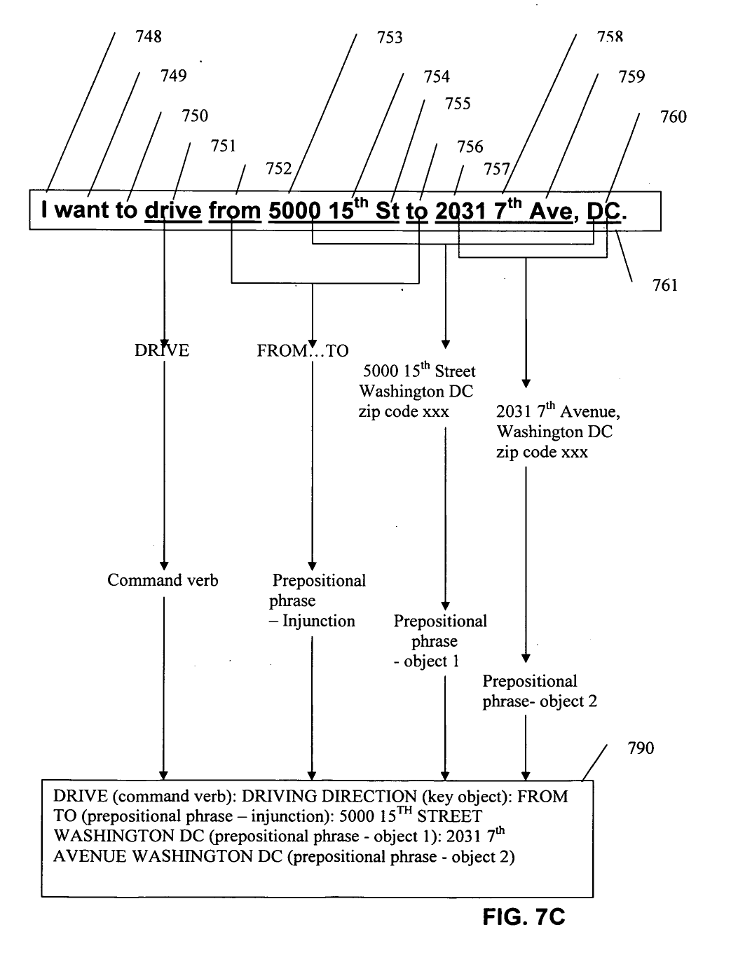

FIG. 7A shows a user input to another embodiment of the present invention that is adopted for use as an Internet command engine. In this example, the user input is “I want to buy a house in Washington DC.” First, the user input should be tokenized into 9 tokens of words. The command verb is “buy,” token 723, and the key object is “house,” token 725. In another example, a person could enter “I want to buy a condominium” instead of a “house.” This embodiment of a command engine is able to process these words to find the right website. Token 726, “in,” is an injunction in prepositional phrase. Tokens 727 and 728 must go together. This embodiment is able to determine that these two nouns go together. Also, tokens 720, 721, 722, 724 are not essential for generating the query. They should be filtered out. While an example was provided for an English input, the invention can be used for other languages.

FIG. 7B shows examples of alternative user inputs that can be used with this embodiment of the present invention in FIG. 7A that is adopted for use as an Internet command engine. Sentences 731, 732, 733, and 734 may produce the same query that the user input in FIG. 7A produces. The words that should be included in the query are “buy,” “house,” “in,” and “DC.”

FIG. 7C shows a user input that can be used in the embodiment of the present invention in FIG. 7A that is adopted for use as Internet command engine and how it can be processed to generate a query. While many sentences can be described as a combination of a verb, an object, and a prepositional phrase, other sentences structures are common. The user input of this example does not have a key object in the sentence. However, if we are to assign a key object, it may very well be described as “driving direction.” The combination of tokens 751 (“drive”), 752 (“from”), and 756 (“to”) signals that the user is looking for a driving direction. Also, certain tokens may be combined with other tokens to be transformed into a query 790. For example, tokens 752 (“from”) and 756 (“to”) go together as a phrase.

How a sentence or a phrase can be parsed into several phrases, tokenized and be tagged according to the part of speech can be accomplished using one or more methods as known in the art, including but not limited to ATN (Augmented Transition Network).

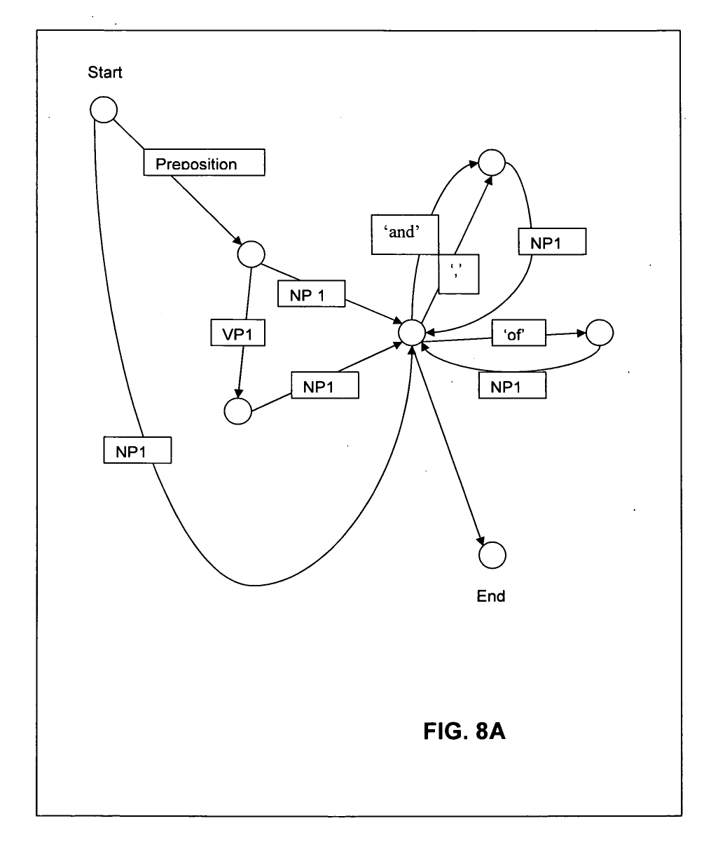

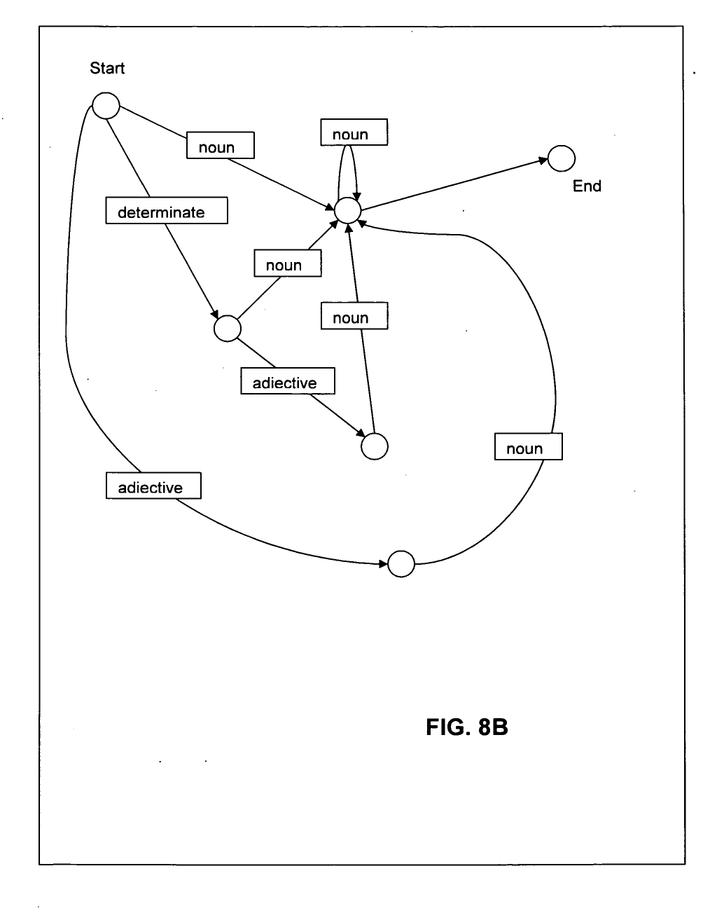

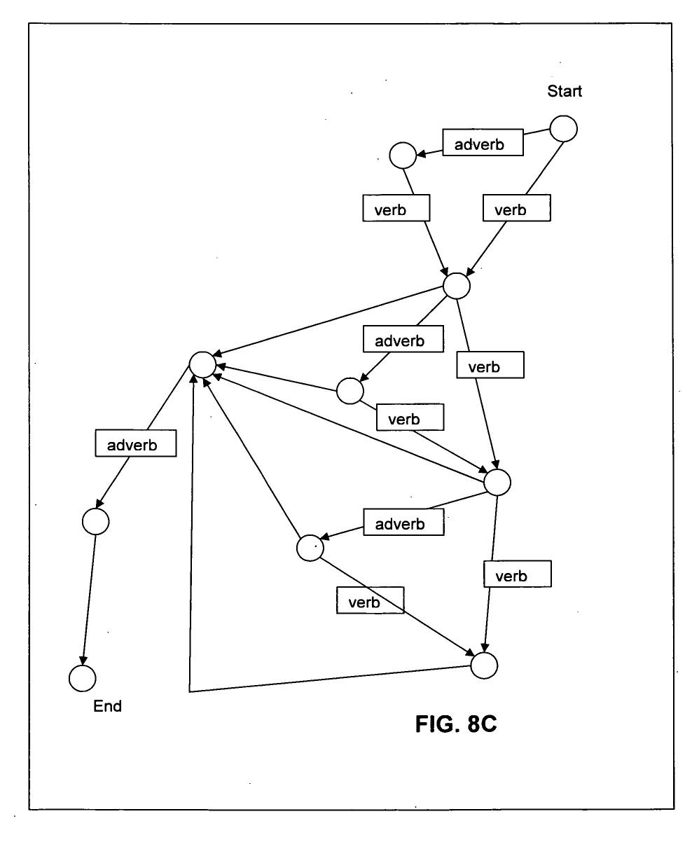

FIG. 8A is a node diagram of a noun phrase grammar network. This diagram provides an insight as to how a sentence or a phrase can be parsed into several tokens and be tagged according to the part of speech of each token. It is provided here only as an example, and there are many other grammar structures that can be used with the present invention. Also, similar method can be used to parse languages other than English.

A noun phrase is a phrase which usually contains a noun or a pronoun, optionally accompanied by a set of modifiers. These modifiers may include: (1) determiners, such as an article; (2) demonstratives, such as “this” or “that”; (3) numerals, such as “two” or “five”, (4) possessives, such as “my” or “their”; (4) quantifiers, such as “some” or “many”; (5) adjectives, such as “red” in “red ball”; and (6) complements, in the form of an adpositional phrase such as “the man with a black hat,” or a relative clause such as “the books that I bought yesterday.” Some modifiers such as articles can often be ignored in understanding the user intention.

An adposition is any of a wide variety of particles and affixes which are attached to a noun phrase in order to modify the noun phrase or show its relation to another concept or situation in the same clause. Adpositions are classified by their placement relative to their object; the most common kinds of adpositions are prepositions, which precede their object, and postpositions, which follow them. An example of preposition is “on” in the sentence “The keys are on the table.”

For example, a user may enter a user input of “I want to shop for a red coffee cup.” The phrase “I want to” can be filtered out. The verb “shop” can be tagged as a command verb. The phrase “for a red coffee cup” needs to be broken down further. Here, “for” is a preposition and “red coffee cup” is a noun phrase. The phrase will go through notes and edges. The phrase may then ultimately be broken down into “a red coffee cup.”

FIG. 8B illustrates how “a red coffee cup” can be broken down further and tagged according to the part of speech of each word. FIG. 8B is a node diagram of a second noun phrase grammar network. This grammar network can accommodate many noun phrases, although not all. For example, a simple noun phrase such as “a cup” will be parsed into “cup” at a node. Although a separate node can be added for an article such as “a,” in this example there is no node for articles. The article “a” can be filtered out. In this noun phrase, “cup” is likely to be the key noun, depending on where this noun phrase was found within a sentence. A noun phrase such as “coffee cup” will be parsed into “coffee” and “cup.” The string will follow an edge, and “coffee” will be separated out at a node, and following an edge, “cup” will be parsed and is likely to be tagged at a node as the key object, depending on where the noun phrase “a red coffee cup” was found in the original sentence. A noun phrase such as “a red coffee cup” will follow different edges and notes.

FIG. 8C is a node diagram of a verb phrase grammar network. A verb phrase is a syntactic structure consisting mainly of main verbs, auxiliary verbs, and other infinitive or participle constructions. For example, in the sentence “John was explaining briefly about the new novel on Egyptian history,” the phrase “was explaining briefly” is the verb phrase. The phrase “was explaining briefly about the new novel on Egyptian history” is the predicate. The phrase “about the new novel on Egyptian history” is a noun phrase. The phrase “on Egyptian history” can be called a prepositional phrase for simplicity. For a simplified embodiment like the one shown in FIG. 7C, the word “on” can be tagged as “prepositional phrase-injunction,” the word “Egyptian” can be tagged as “prepositional phrase-adjective”, and the word “history” can be tagged as “prepositional phrase-object.”

The verb phrase “was explaining briefly” can be parsed by going through the various nodes and edges. The token “explaining” can be transformed into “explain” and be tagged as the main verb of the sentence. The location where the token was tagged yields useful information about the relevance of the token in the data retrieval process.

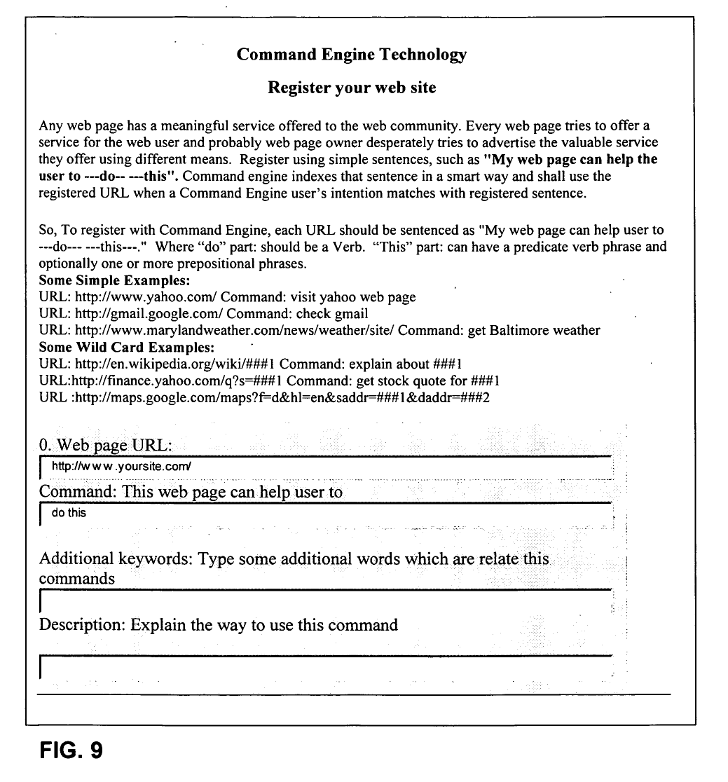

FIG. 9 is a screen shot of a sample website registration form of the present invention, adopted for use in an Internet command engine. As explained earlier, there are different methods for implementing an index building mechanism. Directory registration is one of them. A website owner can visit the registration page, fill out the form, and make the owner's website available in an Internet command engine. For example, the user can enter a URL in the Webpage URL field, a command verb in the “Command” field, and a key object and one or more prepositional phrases in the “Additional keywords” field. The owner can also provide a description of his website. If the website provides web service through the use of XML, the XML codes can be placed in such fields. Providing a registration page eliminate the need of the command engine to create every entry of the index.

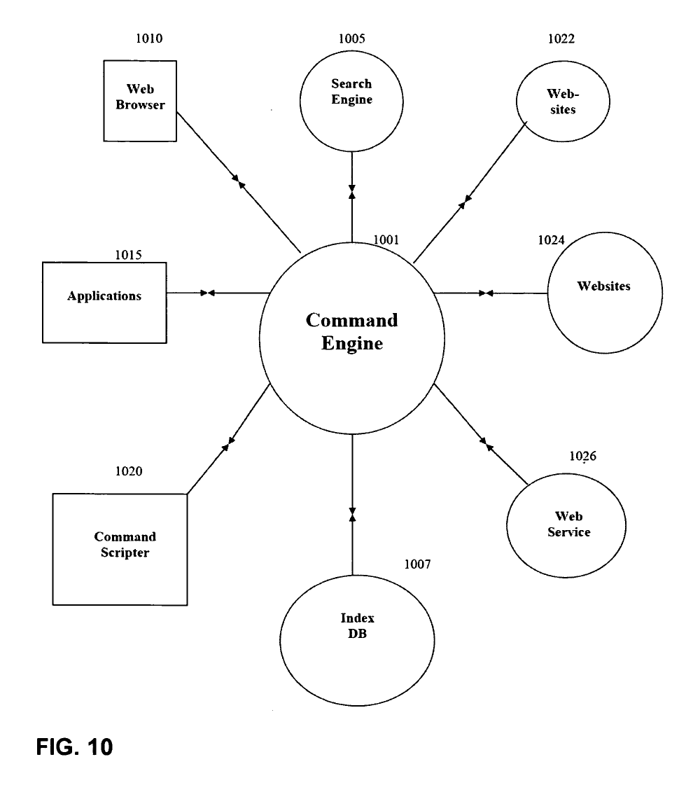

FIG. 10 shows an example of a command engine of the present invention. A web browser 1010 or any one or more applications 1015 (such as a phone, iPod, personal computer, etc) can be used to interact directly with a command engine 1001 of the present invention. Furthermore, a command scripter 1020 can be used to handle multiple commands. For example, as discussed, a user may have several command engine 1001 queries that he or she may need to check each morning. For example, the user may need to receive stock quotes for her portfolio, check the weather and traffic, and receive the latest news each morning. The command scripter 1020 can manage and handle the multiple number commands that a user may need. The command scripter 1020 may help reach the relevant website using the command engine to pull up the desired result, wherein such functions can be accomplished automatically or in timed intervals.

Also as discussed, when the command engine 1001 cannot understand the query or when the query request for a search, the command engine 1001 can default to one or more search engines 1005. The command engine 1001 connects a user's intentions, presented as structured sentences as discussed, with the functionalities and capabilities of one or more websites 1022, 1024 and 1026.

Sample commands, for illustrative purposes only and not as a limitation whatsoever, are listed as follows:

Small Business
buy italian designed shoes in Fairfax Va.
buy fresh vegetables in 34563 zip code
fix lawn mower in Tracy, Calif.
rent home in bay area

Apple/iPod
download MP3 music
Download - - - album. (to download a particular album)

Google
get driving direction from - - - to - - -

Weather.com
check weather for - - - (any address, zip, state, county, etc.)

Traffic Report
check traffic report for the route from - - - to - - -

Real Estate
buy homes in - - - area with price more of - - -
buy homes in - - - area with price less of - - -
Sun Microsystems buy highend servers
buy USB convert for SUN servers
download java

T-Mobile
check remaining cell minutes
apply for unlocking my cell phone
get current Cellphone Family plan deals

Wikipedia
get meaning of word - - -
define the word - - -
JFK airport
check flight no - - - status
check arrival time for flight no - - -

South West Airlines
book flight ticket from - - - to - - -
check price for flight ticket from - - - to - - -

Pizza Hut
eat at Pizza Hut in **** zipcode
order pizza online
order pizza by phone.

Bank of America
open checking account online
refinace my equity loan
pay bill using online account
order free credit report for a year

Government
Download sales tax forms
Learn about SSN rules
Download - - - federal tax forms. (1040, 540, etc)
Discover Md. (Md. tourism department)
Visit Baltimore

No-Profit Organizations
donate money for christian kids education
fix homes for katrina victims

Individual
buy 2000 honda accord LX used car for 8000 dollars
rent home with one year lease
learn guitar in the weekends in the Pikesville, Md. area

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breath and scope of the present invention should not be limited by any of the above-described exemplary embodiments, but should be defined only in accordance with the following claims and their equivalents.

What is claimed is:

1. A method of retrieving information from the Internet using a command engine by taking into account parts of speech of a user input to correlate user intentions with website capabilities, thereby reducing one or more steps involved in retrieving said user intended information, said method comprising:
(a) entering said user input into said command engine, wherein said user input further comprises a command grammar structure comprising:
i. a verb phrase signifying intended action of said user intentions, wherein said verb phrase is entered in a verb-input field denoted by “do”;
ii. an object phrase signifying intended object of said user intentions, wherein said object phrase is entered in an object-input field denoted by “what”;
iii. wherein said object phrase optionally further comprises one or more prepositional phrases, wherein said prepositional phrases provide additional information regarding user intentions;
(b) processing said user input to generate a command engine query, wherein said command engine query further comprises a verb-phrase query and an object-phrase query, optionally having one or more prepositional-phrase queries;
(c) processing said command engine query, wherein each of said verb-phrase query, object-phrase query, and optionally one or more prepositional-phrase query, is compared to corresponding verb-phrase information database, object-phrase information database, and optionally one or more prepositional-phrase information databases, wherein said information databases comprise collection of information gathered from the Internet using methods selected from the group consisting of: manual processing, website publisher input, and automatic crawlers;
(d) generating an output, wherein said output displays results directly correlating with said user's intentions.

2. The method according to claim 1, wherein processing said user input further comprises parsing said user input to correlate said user input with said command grammar structure.

3. The method according to claim 1, wherein processing said user input further comprises tokenizing said user input.

4. The method according to claim 1, wherein processing said user input further comprises tagging words used in said user input into one or more grammatical categories.

5. The method according to claim 1, wherein processing said user input further comprises tagging words using an augmented transition network.

6. The method according to claim 1, wherein processing said user input further comprises using noise filters to eliminate unnecessary words.

7. The method according to claim 1, wherein processing said user input further comprises using banyan tree modules to reduce redundancy.

8. The method according to claim 1, further comprising the step of searching the web using words used in said user input as a default when said user input is not recognized as said command grammar structure.

9. The method according to claim 1, wherein said user input comprises a single sentence structure.

10. The method according to claim 1, wherein said command grammar structure comprises a format correlating to:
User Input=“Help me to”+<verb phrase>+<object phrase>+0 or more <prepositional phrase>.

11. The method according to claim 1, wherein said each prepositional phrase comprises a preposition and one or more noun phrases.

12. The method according to claim 1, wherein said manual processing comprises said command engine administrator visiting various websites and indexing website capabilities.

13. The method according to claim 1, wherein said website publisher input comprises one or more website publishers entering website information and capabilities.

14. The method according to claim 1, wherein said automatic crawlers automatically populate said command engine databases with website capabilities.

15. The method according to claim 1, wherein multiple user inputs are processed simultaneously to retrieve outputs corresponding with said user inputs.

16. The method according to claim 1, wherein said information databases comprise one or more types of information selected from the group consisting of indexes, tables, storage information, key words, wild card information, descriptions, and URL information.

17. A command engine for retrieving information from the Internet by taking into account parts of speech of a user input to correlate user intentions with website capabilities, thereby reducing one or more steps involved in retrieving said user intended information, said command engine comprising:
(a) a command engine query input field for entering said user input into said command engine, wherein said user input further comprises a command grammar structure comprising:
i. a verb phrase signifying intended action of said user intentions, wherein said verb phrase is entered in a verb-input field denoted by “do”;
ii. an object phrase signifying intended object of said user intentions, wherein said object phrase is entered in an object-input field denoted by “what”;
iii. wherein said object phrase optionally further comprises one or more prepositional phrases, wherein said prepositional phrases provide additional information regarding user intentions;
(b) a processor for processing said user input to generate a command engine query, wherein said command engine query further comprises a verb-phrase query and an object-phrase query, optionally with one or more prepositional-phrase query;
(c) wherein each of said verb-phrase query, object-phrase query, and optionally one or more prepositional-phrase query, is compared to corresponding verb-phrase information database, object-phrase information database, and optionally one or more prepositional-phrase information databases, wherein said information databases comprise collection of information gathered from the Internet using methods selected from the group consisting of: manual processing, website publisher input, and automatic crawlers;
(e) an output generator displaying output, wherein said output displays results directly correlating with said user's intentions.

18. The command engine according to claim 17, wherein said processor further comprises a parser for parsing said user input to correlate said user input with said command grammar structure.

19. The command engine according to claim 17, wherein said processor further comprises a tokenizer for tokenizing said user input.

20. The command engine according to claim 17, wherein said processor further comprises a tagger for tagging words in said user input into one or more grammatical categories.

21. The command engine according to claim 17, wherein said processor further comprises a tagger for tagging words in said user input using an augmented transition network.

22. The command engine according to claim 17, wherein said processor further comprises a noise filter for eliminating unnecessary words in said user input.

23. The command engine according to claim 17, wherein said processor further comprises a banyan tree module to reduce redundancy in said user input.

24. The command engine according to claim 17, wherein said processor further comprises a search engine for searching the web using words in said user input as a default when said user input is not recognized as said command grammar structure.

25. The command engine according to claim 17, wherein said user input comprises a single sentence structure.

26. The command engine according to claim 17, wherein said command grammar structure comprises a format correlating to:
User Input=“Help me to”+<verb phrase>+<object phrase>+0 or more <prepositional phrase>.

27. The command engine according to claim 17, wherein said each prepositional phrase comprises a preposition and one or more noun phrase.

28. The command engine according to claim 17, wherein said manual processing comprises said command engine administrator visiting various websites and indexing website capabilities.

29. The command engine according to claim 17, wherein said website publisher input comprises one or more website publishers entering website information and capabilities.

30. The command engine according to claim 17, wherein said automatic crawlers automatically populate said command engine databases with website capabilities.

31. The command engine according to claim 17, wherein multiple user inputs are processed simultaneously to retrieve outputs corresponding with said user inputs.

32. The command engine according to claim 17, wherein said information databases comprise one or more types of information selected from the group consisting of indexes, tables, storage information, key words, wild card information, descriptions, and URL information.
